(19) United States
(12) Patent Application Publication
(10) Pub. No.: US 2015/0339693 A1
(43) Pub. Date: Nov. 26, 2015

(54) DETERMINATION OF INITIAL VALUE FOR AUTOMATED DELIVERY OF NEWS ITEMS

(71) Applicant: Qbeats Inc., New York, NY (US)

(72) Inventor: Illan Poreh, Miami Beach, FL (US)

(73) Assignee: Qbeats Inc., New York, NY (US)

(21) Appl. No.: 14/719,279

(22) Filed: May 21, 2015

Related U.S. Application Data
(60) Provisional application No. 62/001,368, filed on May 21, 2014.

(51) Int. Cl. G06Q 30/02

(52) U.S. Cl. CPC G06Q 30/0206; G06Q 30/0282

(57) ABSTRACT

Methods, systems, and apparatus, including computer programs encoded on computer storage media, for receiving, from a user interface running on a publisher device, a baseline price for the article; receiving, from the user interface text and metadata of the article, the metadata comprising at least a genre for the article; determining, using one or more processors at a server system, a plurality of weights from the text and the metadata; applying, at the server system, the plurality of weights to the baseline price to generate the initial price of the article; and providing the initial price from the server system to a customer device for display at the device.

### RELATED CASES

This application claims benefit to U.S. Provisional Application 62/001,368, filed May 21, 2014, which is herein incorporated by reference in its entirety.

This application incorporates by reference the entire contents of the following patent applications:

(1) PCT application PCT/US12/39129 filed May 23, 2012;

(2) U.S. application Ser. No. 13/404,957 filed Feb. 24, 2012;

(3) PCT Application No. PCT/US13/54222 filed Aug. 8, 2013;

(4) PCT Application No. PCT/US13/54223 filed Aug. 8, 2013;

(5) PCT Application No. PCT/US13/54224 filed Aug. 8, 2013;

(6) PCT Application No. PCT/US13/54225 filed Aug. 8, 2013;

(7) PCT Application No. PCT/US13/54226 filed Aug. 8, 2013;

(8) PCT Application No. PCT/US13/54228 filed Aug. 8, 2013;

(9) PCT Application No. PCT/US13/54229 filed Aug. 8, 2013;

(10) PCT Application No. PCT/US13/54231 filed Aug. 8, 2013.

### BACKGROUND

In general terms, a content delivery system operates over communication links such as the Internet, and provides a convenient, automated way for publishers such as individual journalists to remotely access the system, enter and receive parameters that may affect the financial or other benefits from publishing an article, post an article together with parameters related thereto, and possibly engage in responding to questions from users or other publishers regarding the article or issues it raises and thus possibly generate additional financial or other benefits. Users at remote locations conveniently establish automated access to the system through which they can effectively identify articles of likely or at least possible interest, read or download them at access prices that dynamically track the actual worth of access based on user behavior and other factors, and possibly post questions related to the articles and receive answers.

### SUMMARY

The applications that are incorporated by reference describe various aspects of a system that provides a particularly effective and user-friendly way to find and read or download news articles and for publishers to publish articles accessible through the system.

The price at which access to an article is offered varies dynamically with time and with other factors, and generally follows an S-shaped curve of access charge vs. time that starts with a higher access charges, keeps dropping with time, and then approaches leveling before the article's lifetime ends and access becomes essentially or completely free. Deviations from a smooth curve of this shape are possible depending on user behavior and other factors, so it is possible that on occasion the access price may sharply go up or down. It is also possible, and indeed may be typical, that the access charge will decrease with increased requests for access by users. For example if a greater number of users have sought access during a time slot, or the rate of access requests has increased, the price per access that is offered will decrease (unlike systems that seek to maximize the price for each transaction and thus would increase the price for a transaction for an item with increase in demand for the item).

Accuracy in the initial valuation of an article is important because it affects the charge per access at least for an early part of the article's lifetime and may and likely will affect readership and the overall revenue from access to the article. For example, if the initial valuation is too high and the access charge is too high at the early part of the article's lifetime, fewer users may request access and readership may decrease when the article is fresh news and should generate high readership. As a result, the pricing engine may drop the access price with time at too high a slope, therefore decreasing overall revenue over the article's lifetime. Conversely, if the initial valuation is too low, the initial access price will likely be lower than it could have been for a significant part of the S-curve, thus also decreasing overall revenue over the article's lifetime compared with a more accurate initial valuation. Additionally, an inaccurate initial valuation may adversely affect the system's relationship with actual or potential publishers and thus reduce the system's input of articles and availability of articles to users.

This patent specification describes examples of processes designed to make the initial valuations of articles more accurate and thus make the system more efficient and more attractive to both users and publishers.

### BRIEF DESCRIPTION OF THE DRAWINGS

FIG. 1 is functional block diagram illustrating a general lifecycle of an article in the system.

FIG. 2 is an expanded version of FIG. 1, material specific to a process for an accurate determination of initial valuations and/or initial access pricing.

Like reference numbers and designations in the various drawings indicate like elements.

### DETAILED DESCRIPTION

A unique aspect of the system is that it is provides users with articles at access fees that are much lower, typically of the order of Cents per access. These access prices tend to decrease dynamically with time and with access by more users because one of the goals can be to increase total revenue over a lifetime of the article. This is in contrast with prior systems that charge fixed fees in the tens of Dollars for access to an article from a professional journal, with little regard to the age of the article or the number of users, or a flat fee that is lower but does not change dynamically, or are designed to sell items from a finite supply, or apply charges that maximize profit for each sold item rather than overall revenue over a lifetime of an article the novelty and thus value of which can decrease dramatically with time. A unique aspect from a publisher's point of view is that a publisher can automatically receive immediate initial estimates regarding likely readership of the articles, initial valuation of financial benefits, lifetime of the article before access becomes essentially or completely free, and other parameters regarding the proposed article.

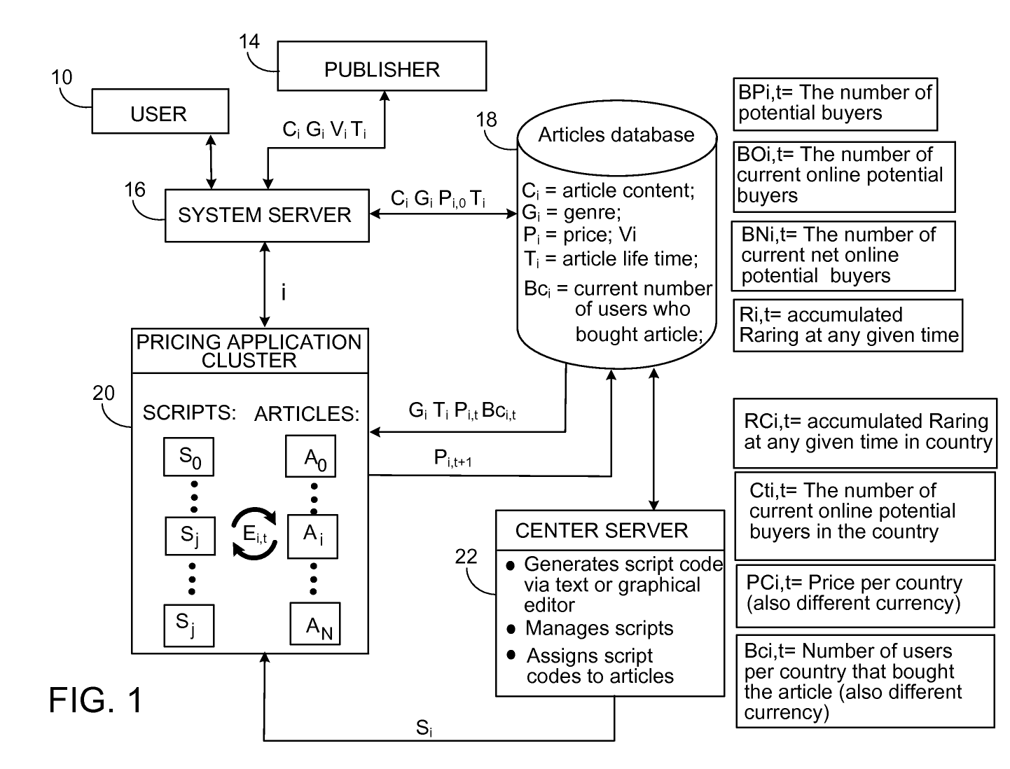

FIG. 1 illustrates in functional form the basic system described in the applications incorporated by reference. Consider the example of a publisher 14, for example a freelance journalist. The publisher is at a location remote from the system and uses a connection mechanism such as a personal computer, a tablet or some other device to establish a two-way electronic communication with a computer-implemented or computer-controlled system server 16, for example using a browser and the Internet. In response, system server 16 downloads to the publisher's device, over an electronic communication link, a screen display through which the publisher navigates and selects actions such as signing on the system, creating an account and/or a profile, changing settings, selecting or creating an active channel or accessing an inactive channel, submitting an article and information pertaining to the article, accessing other articles (and questions or comments thereon), uploading answers to questions posted by others, commenting on articles, etc., and signing out.

A typical input that a publisher provides when submitting an article identified by an index i (where i can be a unique number associated with the article) comprises the article content Ci, analysis information such as a genre designation Gi of the article and a synopsis of the article and keywords from or about the article, a value Vi that the publisher proposes for the article, and an initial lifetime Ti that the journalist proposes for the article. System server 16 receives this information and subjects it to initial automated, computer-implemented processing. For example, based on information stored in the system and on rules applied by the operation of computer programs in system server 16, the system server sets an initial price Pi,o for access to the article, and may change the genre designation Gi and the keywords associated with the article, and may change the value Vi and the initial lifetime Ti that the journalist proposed to a higher or lower value and/or a shorter or longer lifetime. This process may involve automated delivery to the publisher's screen of information about the likely interest of users and other publishers in the article and the likely revenue from access to the article, including information on likely current users who may be interested, likely future users, changes in the number and geographical distribution of likely accesses to the article, likely changes in pricing access to the article over time or in relation to other factors, etc., to thereby help publishers in the initial pricing and characterization of the article and in possible revisions therein, and with respect to possible future articles.

Basic operations of the equipment of with FIG. 1 or related figures in the patent applications incorporated by reference are not repeated in this patent specification because they are described in detail in the material incorporated by reference.

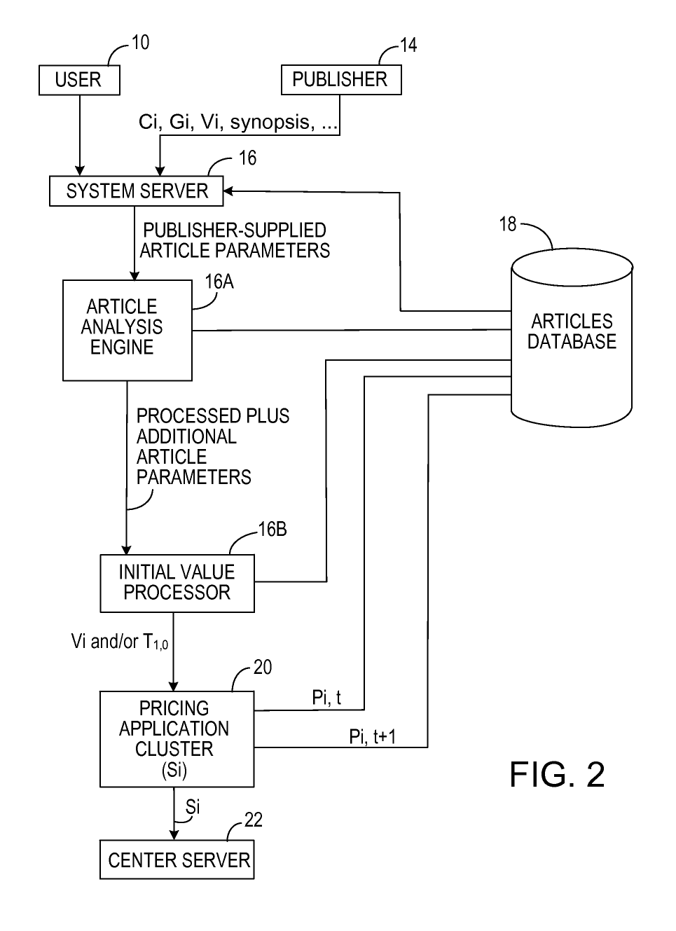

FIG. 2 shows an example system server that can be implemented as computer programs on one or more computers in one or more locations, in which the systems, components, and techniques described below are implemented.

Referring to FIG. 2, a publisher 14 such as a journalist connects with system server 16 such as over the Internet using a common browser, transmits an offer of an article i and typically provides the article content Ci and parameters related to the article such as genre designation Gi, a publisher-proposed lifetime Ti for the article, and possibly a synopsis and keywords.

These can be provided through a user interface of the browser running on a client device. The client device can include a memory, e.g., a random access memory (RAM), for storing instructions and data and a processor for executing stored instructions. The memory can include both read only and writable memory. For example, the device can be a computer coupled to the system server through a data communication network, e.g., local area network (LAN) or wide area network (WAN), e.g., the Internet, or a combination of networks, any of which may include wireless links.

The device can be a smartphone, tablet, a desktop computer, or a laptop computer. The device is capable of receiving user input, e.g., through a touchscreen display or a pointing device, e.g., a mouse or a keyboard.

The user interface can include user input fields for text and metadata of the article. The text fields can prompt a user to provide content, i.e., text, and a genre of the article. In some implementations, the client device identifies a system time and determines its location and sends the location to the system server 16. The client device can send data from the user input fields to the system server 16.

System server 16 includes or is associated with an article analysis engine 16a that subjects the article and its parameters to an analysis to confirm or modify the parameters that the publisher supplied and typically generate additional parameters, with assistance of historical and other information from articles database 18, to thereby output a set of processed and possibly additional article parameters. An example of such additional parameters is set out in the example of an initial valuation discussed further below. An initial value processor 16b subjects this set of parameters to a process that accounts for estimated importance of different parameters with respect to pricing, to thereby produce an initial value Vi for the article and/or an initial access price Pi,o, and supplies the resulting information and possibly some or all of the set of processed plus additional article parameters to articles database 18. Articles database 18 stores Ci and related parameters and supplies some or all of the parameters to pricing application cluster 20, which is a part of a pricing engine and applies scripts Si to those parameters to thereby generate an access price Pi,t+1 for each new time increment, e.g. every second or some other time increment.

As described in the material incorporated by reference, pricing application clusters applies a respective set of one or more scripts Si to an article i, which scripts are supplied from a center server 22 and can change from time to time, including during the lifetime Ti of the article. Pricing application cluster 20 makes access price Pi,t+1 available to users 10 through articles database 18 and system server 16 (or more directly). The process of supplying access price

Pi,t+1 to articles database 18 then supplying current article parameters from article database 18 to pricing application cluster 20, where the current scripts Si are applied to generate a new access price after a time increment, is repeated throughout the lifetime Ti of the article. As a result, the access price varies over time in a manner that accounts for user behavior regarding the article and other material or events, and typically follows a smooth S-curve, with possible occasional, short-duration, sharp excursions up or down.

A hypothetical example may help illustrate the process, understanding that it is one of many possible ways according to this patent specification to select parameters affecting pricing, scripts Si, and ways to apply the scripts, and does not limit the scope of the novel aspects of this patent specification.

For this example, assume that a the publisher 14 is a Wall Street Journal journalist who breaks a story at 10:00 am Monday NYC time about a merger of two significant US companies and immediately offers the story via system server 16. Assume for simplicity and round numbers that that the journalist or the system has set a baseline initial valuation price of $1 for the article, in a process of the type discussed in the applications incorporated by reference that takes into account historical information regarding pricing of similar articles, number of users signed on the system at the time, etc.

In this example, initial value processor (which may be a part of application cluster 20) subjects the baseline price to a set of scripts Si that weight the baseline price with respective multipliers for respective parameters and sum the products to arrive at an initial valuation. For example, the calculation can be: Initial price of the article=$1 (Baseline)×1.30 (Genre-Breaking News)×1.10 (article includes 2 charts)×1.20 (audience score—article appears in 14 channels)×1.10 (market signals—2 indexed public companies are mentioned in the article)×1.15 (unexpected event—based on repeated use of the word “merger”)×1.30 (Publisher rating—Wall Street Journal)×1.10 (geography: location of the story—USA)×1.10 (geography: journalist in NYC)×1.30 (time of the day)×5.00 (uniqueness score—the story is truly unique with O instances of a match to others in the system and on the web.)=$22.19. This initial valuation can then be used as described in the material incorporated by reference to arrive at the initial access price and to update the access price with increments of time.

In some implementations, the multipliers, i.e., weights are predetermined and stored in the article analysis engine 16a. In the example where a baseline price is weighted using multipliers, the following set of article parameters A-H and multipliers for each parameter variation can be used as a non-limiting example of the described process:

A. Genre Gi (This parameter is a nature of an article. As with each of the parameters below, the variation within the parameter can be specified by the publisher when submitting the article to the system, or by the system through an automated analysis of the article, or by some combination of the two, or in some other way). The multipliers can be:
Breaking news—1.30×
Rumor—0.90×
Transcript/Verbatim—1.1 O×
Opinion—0.90×
Live—1.20×
Poll/Survey—0.80×
Research—1.30×

In some implementations, the genre is provided by user input from the publisher 14. In some other implementations, the article analysis engine 16a determines the genre from text of the article using a model that classifies news articles into genres. The article analysis engine 16a can select a weight, e.g., from a database, corresponding to the classified genre.

B. Media/Graphs/Charts (This parameter is the presence and number of different media types in the article):
Add photo—plus 0.10
(Article+Photo=1.00+0.1 O=1.1 O×)
Add video—plus 0.20 for every 60 seconds
Add charts/graphs/table—plus 0.05 per chart, graph, or table

In some implementations, the article analysis engine 16a analyzes the article to determine a number of attachments to the article. The article analysis engine 16a can determine if the article includes a type of media attachment with the text of the article. For example, the article analysis engine 16a can identify whether the article includes internet media types, e.g., MIME types.

The article analysis engine 16a can send the determination to the initial value processor 16b, which can select a weight based on a number of attachments to the article.

C. Audience rating score (This parameter is a measure of the number of users that might be interested in the article and relates to the number of channels to which the article would be assigned, based on an automated analysis of its contents. A single article may appear in multiple channels. For example, an article about Zinc would appear automatically in three channels: Zinc, Non-Ferrous Metals, and Metals. The audience score is based on the # of users subscribed to all news channels to which the article pertains.).

# of Channels
1 0.35×
2 0.45×
3 0.55×
4 0.65×
5 0.75×
6 0.80×
7 0.85×
8 0.90×
9 0.95×
10 1.00×
11 1.05×
12 1.10×
13 1.15×
14 1.20×
15 1.25×

Above 15 +0.05 with a cap of 2.00×

In some implementations, the article analysis engine 16a determines an audience rating score, which is used as a weight. The audience rating score can be based on how many channels are assigned to the article.

The article analysis engine 16a can assign the article to multiple channels based on recurring text of the article. For example, if the article includes numerous recurrences of the word “gold,” the article analysis engine 16a can assign the article to the gold channel. In some implementations, the article analysis engine 16a assigns channels based on a threshold number of occurrences of a particular word. The article analysis engine 16a can include a database that maps a number of occurrences of a particular word to a corresponding channel.

The articles database 18 can maintain a database of channels. Each channel can have a number of subscribers. Any particular article can be published within a channel, and this can notify subscribers of the channel of the particular article.

The article analysis engine 16a can receive information about the number of channels associated with the article and also the number of users subscribed to the channels, from the articles database 18. The article analysis engine 16a can generate the audience rating score from the information, and the article analysis engine 16a can select a weight that corresponds to the audience rating score.

D. Market Signals (This parameter pertains to an analysis of the market signals extracted by text analytics and establishes whether the article might create a market moving price change in a tradable security. For example, if the article informs of a company's significantly raised projection of earnings, this parameter may result in a multiplier of, say, 1.1 O×.)

In some implementations, the article analysis engine 16a identifies a number of public companies reference in the article. The number of referenced public companies can be directly proportional to a weight based on market signals.

In some implementations, the article analysis engine 16a identifies certain market-centric phrases in the article. The market-centric phrases can be predetermined by the article analysis engine 16a. In some implementations, the article analysis engine 16a compares similarity of text in the article with the predetermined market-centric phrases. If the comparison satisfies a particular threshold, the article analysis engine 16a can select a weight based on the threshold.

E. Unexpected Events (This parameter pertains to unexpected events that can be defined as articles which include any of the following words or phrases: upgrade, downgrade, merger, acquisition, sale, new patent, new invention, new product, earthquake, hurricane, tsunami, etc.)

| | |
|---|---|
| 0 Unexpected events words | 1.00x |
| 1 | 1.05x |
| 2 | 1.10x |
| 3 or more | 1.15x |

In some implementations, the article analysis engine 16a identifies phrases that pertain to unexpected events. The phrases can be predetermined by the article analysis engine 16a. In some implementations, the article analysis engine 16a compares similarity of text in the article with the predetermined unexpected event-phrases. If the comparison satisfies a particular threshold, the article analysis engine 16a can record the occurrence. The number of occurrences can be directly proportional to the respective weight applied to the baseline price.

F. Publisher rating score (Publisher rating is dependent upon actual user rating as well as known historical data about the Publication. The following is an example of a rating based on the known historical data:)
Established Top Tier Business Publication (e.g., Wall Street Journal, Financial Times
1.30×

In some implementations, the article analysis engine 16a identifies a publisher from metadata of the article. The metadata can be provided by the publisher 14. In some implementations, the article analysis engine 16a determines whether the article is sent from a predetermined list of publishers. If it is, the article analysis engine 16a can select, based on a predetermined weight per publisher stored in a database, an increased weight to apply to the baseline price.

In some other implementations, the weight of the articles depends on a publisher rating. Each article is associated with a publisher, and each article can be rated by users. The rating can be stored in the articles database 18. The rating of the article can proportionally determine a rating of the publisher. The article analysis engine 16a can use the publisher rating to determine the weight for the article.

G. Geography/Temporal Factors (This set of parameters pertains to the location related to the article's content, the location of the journalist, and the time the article becomes available.)

Location of the article:
Major Industrial Nation 1.1 O×
Other significant Nation 1.00×
Less significant Nation 0.90×

Location of the Journalist:
Major City 1.10×
Other Significant City 1.00×
Less Significant Location 0.90×

Date/Time of Day:
At least one Tier 1 Stock exchange is open 1.30×
All Tier 1 Stock Exchanges are closed, but 1.00×
at least one Tier 2 Stock Exchange is open
All tier 1, Tier 2, and Tier 3 Stock exchanges 0.70× are closed.

In some implementations, when submitting the article, the publisher 14 includes a geo-location. The geo-location can be obtained through user input or location hardware of the client device used by the publisher 14. The publisher's location can be used to determine a particular weight to be applied to the baseline price.

In some implementations, the client device, when submitting the article, includes a timestamp of the device in the metadata of the article. The article analysis engine 16a can determine whether the timestamp is within or outside of a predetermined range, e.g., stock exchange trading hours. If the timestamp is inside the range, the article analysis engine 16a can select a higher weight for the article than if the timestamp is outside the range.

In some implementations, article analysis engine 16a analyzes text of the article to determine locations referenced in the article. The article analysis engine 16a can use a classifier to determine the locations. In some implementations, the article analysis engine 16a compares portions of text in the article to a list of frequent locations. If there is a match, the article analysis engine 16a can select a weight corresponding to the matched location, e.g., from a database mapping locations to weights.

H. Uniqueness rating score (This parameter pertains to an evaluation of a number of instances of a match to other articles in the system and on the web and how closely it matches (%) 0 instances of a match defines a completely unique article; 100% match with more than 10 instances of a match defines the least unique article. The score can range from 0.05× to 5.00×.)

In some implementations, the article analysis engine 16a sends the article to be weighted to the article database 18, which can compare the article with other articles in the article database 18. The article database 18 can match the article based on genre or a number of matches of text in of the compared articles.

As noted, the above example is one of the many ways to implement the new way of arriving at access pricing, and there can be other implementations. For example, different or additional multipliers can be used, the process can use a different mathematical technique relying on functions of relevant parameters that are expressed other than as multipliers, so long as the principle is maintained of arriving at an accurate estimate of an initial valuation and initial access pricing that reasonably reflects the influence of historical and current factors that bear on a goal such as overall revenue from users' access to an article over the article's lifetime and other goals that a designer of a specific system implementation sets.

The described process for accurately estimating an initial valuation and/or initial access price can be implemented by programming one or more general purpose computers, or can be implemented in whole or in part in special purpose processors or other computer equipment built or programmed to carry out some or all of the described functions, or as a set of computer instructions stored in non-transitory manner on a computer-readable medium that, when loaded into a suitable computer system, cause the system to carry out the describer process.

It should be apparent from the complexity of the process and the need to process many factors and repeat the process at a high rate of speed, e.g., every second or a fraction of a second, that computer equipment is an essential part of any implementation.

Thus, in one example of the disclosed system and process, a publisher of a news article provides an article and parameters related to the article, and article analysis engine analyses the publisher-supplied article and parameters to confirm or modify them and add additional parameters and thereby generate a set of processed plus additional parameters, an initial value processor uses historical and current factors to increase or in some cases decrease a baseline value assigned to the article and thereby generate an initial estimated valuation of the article or an initial access price for the article, and a pricing application cluster repeatedly, in a rapid sequence, applies a set of scripts to the access price and related factors provided from an articles database to dynamically update the access price so it generally follows an S-shaped curve of access price vs. time during the lifetime of the article, with possible occasional sharp up or down excursions related to unusual event regarding the article or its subject matter.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To send for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can send input to the computer. Other kinds of devices can be used to send for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for determining an initial price of an article for sale, comprising:
receiving, from a user interface running on a publisher device, a baseline price for the article;
receiving, from the user interface text and metadata of the article, the metadata comprising at least a genre for the article;
determining, using one or more processors at a server system, a plurality of weights from the text and the metadata;
applying, at the server system, the plurality of weights to the baseline price to generate the initial price of the article; and
providing the initial price from the server system to a customer device for display at the device.

2. The method of claim 1, where the metadata further comprises at least one or more of the following: a number of different media types in the article, a location of an author of the article, or a time the article is available.

3. The method of claim 1, where determining a particular weight in the plurality of weights comprises:
associating the article with one or more channels based on the text and the metadata;
determining an audience rating score for the article from a number of subscribers to the one or more associated channels; and
determining the particular weight from the audience rating score.

4. The method of claim 1, where determining a particular weight in the plurality of weights comprises:
analyzing text of the article to identify one or more market signals; and
determining the particular weight from the one or more market signals.

5. The method of claim 1, where determining a particular weight in the plurality of weights comprises:
analyzing text of the article to identify one or more unexpected events; and
determining the particular weight from the one or more unexpected events.

6. The method of claim 1, where determining a particular weight in the plurality of weights comprises:
identifying a publisher associated with the article from the metadata; and
determining the particular weight from the publisher.

7. The method of claim 1, where determining a particular weight in the plurality of weights comprises:
analyzing text of the article to identify one or more locations referenced in the article; and
determining the particular weight from the one or more locations.

8. The method of claim 1, where determining a particular weight in the plurality of weights comprises:
comparing text of the article with text from other articles for sale;
determining a uniqueness rating score from the comparison; and
determining the particular weight from the uniqueness rating score.

9. The method of claim 1, further comprising:
sending the initial price to a pricing engine, where the pricing engine repeatedly updates the initial price of the article to generate a sales price of the article, where generating the sales price is based on parameters associated with the article, where the parameters comprise at least a history of user access to the article.

10. A non-transitory computer-readable medium having instructions stored thereon, which, when executed by a processor, cause the processor to perform operations comprising:
receiving, from a user interface running on a publisher device, a baseline price for the article;
receiving, from the user interface text and metadata of the article, the metadata comprising at least a genre for the article;
determining, using one or more processors at a server system, a plurality of weights from the text and the metadata;
applying, at the server system, the plurality of weights to the baseline price to generate the initial price of the article; and
providing the initial price from the server system to a customer device for display at the device.
